(19) United States
(12) Patent Application Publication
(10) Pub. No.: US 2018/0358853 A1
(43) Pub. Date: Dec. 13, 2018

(54) NOVEL ALTERNATOR PRODUCING HIGH AMOUNTS OF ELECTRICITY WITH LOW COST

(71) Applicant: Murat ATALAR, Istanbul (TR)

(72) Inventor: Murat ATALAR, Istanbul (TR)

(21) Appl. No.: 15/780,234

(22) PCT Filed: Dec. 15, 2016
(86) PCT No.: PCT/TR2016/050499

§ 371 Date: May 30, 2018

(30) Foreign Application Priority Data
Dec. 16, 2015 (TR) 2015/16193

(51) Int. Cl. H02K 1/27; H02K 7/00

(52) U.S. Cl. CPC H02K 1/2706; H02K 7/003

(57) ABSTRACT

The novel alternator which is provided to be smaller in size by changing the magnetic field and coil interaction relationship in present alternators, which utilizes the magnetic field more efficiently, and which has a design such that it produces higher amounts of electricity and provides production processes with lower costs, is basically formed of two main parts. One of the parts is the single piece coil which enables to produce high voltage electricity that is formed with high amounts of windings and the other is a magnet-core combined part which rotates at the centre of the coil by means of a shaft.

### CROSS REFERENCE TO RELATED APPLICATIONS

This application is the national phase entry of International Application No. PCT/TR2016/050499, filed on Dec. 15, 2016, which is based upon and claims priority to Turkey Patent Application No. 2015/16193, filed on Dec. 16, 2015, the entire contents of which are incorporated herein by reference.

### TECHNICAL FIELD

The present invention is to provide a more efficient, productive and low cost electricity energy production by re-designing the winding and motion relationship in coils and magnets.

### BACKGROUND

Several types of coils and shapes can be provided in present alternators. Together with this, designs where the magnets are located in a radial plane, and the coils are located in another radial plane and where one of said planes are fixed and the other rotates is used in basic alternators.

### SUMMARY

The numbers of the coil windings and the numbers of said coils need to be increased in order to increase the power of the alternators in present alternators. Therefore the size of the alternator also needs to be increased at a similar rate. This situation significantly increases costs and makes production more difficult.

In new generation alternators however:
the same amount of electricity can be produced using small sized alternators,
high voltages can be obtained without needing positive booster transformers,
costs will be reduced by means of using less material,
the need for complex production processes shall decrease as the technique used is simpler and production shall be easier.

### BRIEF DESCRIPTION OF DRAWINGS

FIG. 1: General design examples of classic alternators

FIG. 2: Relation of magnetic field and electricity production in classic design

FIG. 3: Side view of the new alternator design

FIG. 4: Front view of the new alternator design

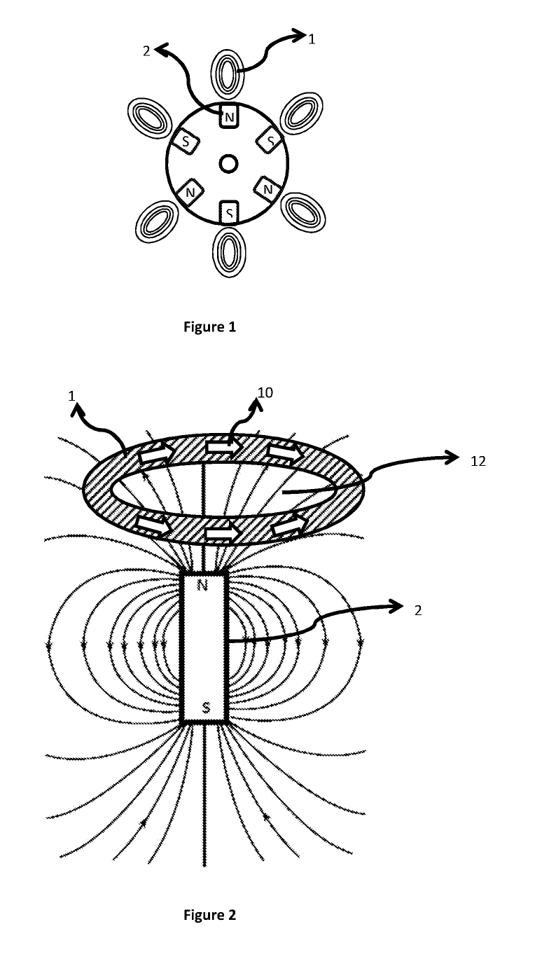

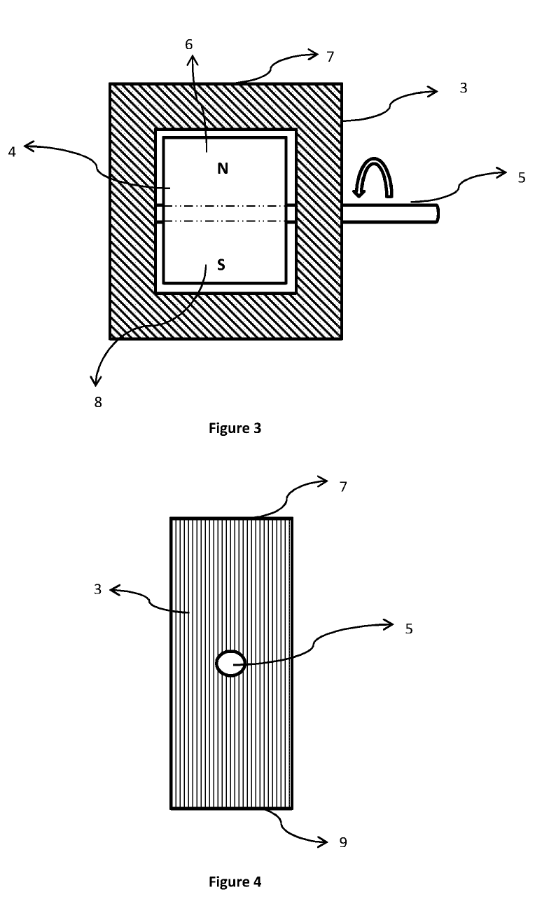

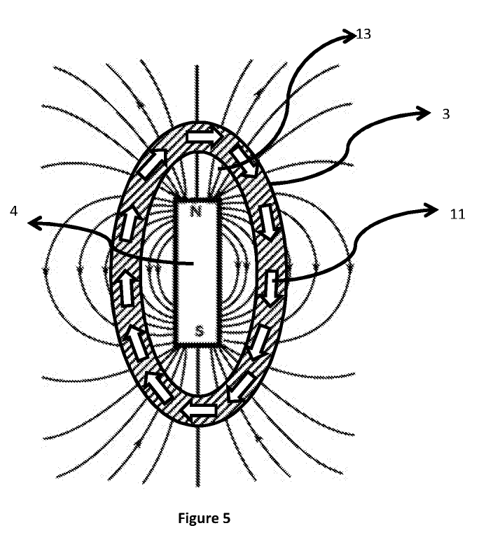

FIG. 5: Relation between the magnetic field and electricity energy in the new design The parts in the figures have each been numbered and their references have been listed below:
1: Classic coil
2: Classic magnet
3: Novel integral coil winding
4: Novel central magnet-core combination part
5: Shaft enabling the rotation of the magnet-core combination part inside the coil
6: N terminal of the magnet-core combination part
7: Coil semi-circle interacting with the N terminal
8: S terminal of the magnet-core combination part
9: Coil semi-circle interacting with the S terminal
10: Reverse direction current created in classic alternator coil windings
11: Same direction current created in novel alternator designs
12: Magnetic field of the classic magnet
13: Magnetic field of the novel magnet

### DETAILED DESCRIPTION

A new design has been created by considering the fact that it shall be inefficient to generate electric energy from the relative movement of conventional classic coils (1) and the classic magnets (2) with each other in different radial planes in known alternators. The invention consists of two basic parts, where the magnet-core combined part (4) is rotated inside by means of a shaft (5) and where the novel single piece coil (3) is wound around this combined part (4). The N terminal (6) of the magnet used within the design, corresponds to the circular part (7) of the coil semi-circle which interacts with the N terminal of the coil and the S terminal corresponds to the coil semi-circle part (9) in which the S terminal interacts with the coil winding. In such a case the electricity current (11) created from the interaction of both terminals are directed in the same direction. The reverse electricity currents (10) created on both sides of the coil in classic designs, neutralize each other when the magnet (2) gets closer to the winding of the coil (1) in classic designs.

As the magnet-core combination part (4) is located at the inner section in the novel design and as the new coil (3) is wound as a single piece at a single direction, it is both easier to be wound and there is no restriction for increasing the winding amount.

The reasons showing how this design shall be more efficient and advantageous have been listed as items below:
A section of the magnetic field in classic designs is in contact with the coil, however, in new designs all magnetic lines cross with the coil. Therefore the electricity energy obtained from a magnet is higher.
The reverse electricity currents (10) created inside the coil in classic designs, neutralize each other. As the forces create current (11) in the same direction in new coil winding designs, instead of neutralization, the energy obtained is further increased.
While it is necessary to increase the size of the alternators in nearly a direct proportion in order to increase power in classic designs, this increase of size in direct proportion is much less in novel alternators.
In classic designs, magnets need to be aligned on a circular plane, whereas in novel designs, the number of the magnets to be used is less as the magnet needs to be placed in the centre only.
In classic alternators separate parts need to be combined and fixed to each other, whereas in new designs the number of parts are less and as a single part coil winding (3) is carried out, production is faster and easier.

When assessed theoretically, the system which is anticipated to be much more efficient, has been produced and tried as a prototype having the dimensions 10 cm×10 cm×6 cm which is not deemed to be a professional system in practice (the space between the magnet and the coil is more than 0.5 cm). This novel alternator prototype in which lkilogram of copper winding is used has enabled the production of 600 Volts of electric energy at 3000 rpm when the load is not connected. 3 light bulbs of 100 W has been installed to this alternator and following the rotation of the alternator with a 550 W drill, the bulbs have been able to be lighted as bright as they would be normally. More copper is used in order to provide an alternator having similar power in classic designs and the size is smaller.

When the results are evaluated, it is understood that higher voltage and power can be obtained with the novel alternator that shall be prepared professionally, having millimetric distances with the same material used to produce the prototype.

As the invention is part of a basic field related to producing electric energy from motion, it shall be effective to the industry and energy policies. The amount of electricity produced shall be increased by means of using novel alternators in wind turbines, electricity plants, (dams, thermal power plants) vehicles and in plants where electricity is produced. Following the increase in the amounts of energy produced, the dependency of Turkey to foreign countries for energy shall be significantly reduced. Additionally as it is easier to reach higher voltages in novel alternators, it shall provide advantages in procedures (increasing energy before distribution, high voltage tests etc.) that necessitate the usage of higher voltages. Another important issue is that when all of these advantages are being provided, production is also easier and the costs are also reduced as less amounts of material is used.

1. A novel alternator, comprising a single piece coil winding, wherein the single piece coil winding enables to produce higher amounts of electricity by ensuring that magnets utilize magnetic field in a correct manner and to produce the higher amounts of electricity power in comparison to classical alternators; a combined part is provided at a centre of the single piece coil winding consisting of a magnet and a core; the combined part is fixed on a shaft; one of a plurality of magnetic terminals (N terminal) formed by the combined part interacts with a first semi-circle of the single piece coil winding to generate a first interaction, while the other of the plurality of magnetic terminals (S terminal) interacts with a second semi-circle of the single piece coil winding to generate a second interaction; wherein the first interaction and the second interaction forms an electric current in a same direction.

2. The novel alternator according to claim 1, wherein the single piece coil winding carries out winding at an desired amount which enables to produce high voltage electricity.
